(19) United States
(12) Patent Application Publication
(10) Pub. No.: US 2016/0317906 A1
(43) Pub. Date: Nov. 3, 2016

(54) Method for Playing a Presidential Educational Game

(71) Applicant: FELIX ERNESTO SOSA, MIAMI, FL (US)

(72) Inventor: FELIX ERNESTO SOSA, MIAMI, FL (US)

(21) Appl. No.: 14/698,363

(22) Filed: Apr. 28, 2015

(51) Int. Cl. A63F 3/00; A63F 13/20

(52) U.S. Cl. CPC A63F 3/00138; A63F 13/20

(57) ABSTRACT

A method for playing a presidential educational game incorporates presidential figures with the classic game of Bingo in one embodiment; and a simple puzzle in another embodiment. The game includes historical figures comprising United States Presidents. The game is played using at least one tablet, featuring square blocks arranged in a grid formation. The blocks are place holders for all the presidents, past and present. Each block contains partial facts about each president, including, without limitation, years that the president served, and the sequential number that the president served relative to other presidents. Each player has a tablet. The president, along with the respective partial facts, are in sequential order on the tablet. The player draws a presidential marker that matches the partial fact in a respective block. The first player to fill the blocks in a predetermined formation, such as horizontal, vertical, or fully filled, wins the game.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to a method for playing a presidential educational game that entertains while also educating about the United States history and specifically, the Presidents of the United States.

The inventor was interested in United States history. The inventor knew that past and present presidents were a key component to the history of the United States. For example, dates of the presidential terns often correlated to famous treaties that dictated the course of the United States. The sequential order of the presidents also helped put the history of the United States in perspective.

The inventor learned that immigrants had to pass tests that included information about the past and present Presidents of the United States. Further, students in civics and government classes also had to take tests that included information about the Presidents of the United States. Through investigation, the inventor learned that this information included, names of the presidents, sequence of the presidents, place of birth, birth date, death date, presidential term dates, party affiliation, and the vice president who served under the president.

However, the inventor recognized a problem in that many people were not aware of presidential facts. Even the sequential order and last names of the president were lacking from most people's knowledge base. This especially posed a problem for immigrants and students.

The inventor decided to develop a data table that included all of the pertinent information about the Presidents of the United States that might be asked on the citizenship-type tests. The information was generally useful for any United States citizen to understand the history of the country more thoroughly. The tablet was designed to teach students various fact relationships. However, the inventor realized that many people found the table to be tedious and boring to learn. The table also required a great deal of repetition and was not always successful, since the interest and concentration span of the people was lost after a short period of time.

Through additional research, the inventor learned that bingo was a popular game of chance. In the game of bingo, a player uses a set of cards with numbers printed on them. The numbers are arranged in five vertical rows, with one row beneath each letter of the word Bingo. A bingo caller shouts out numbers printed on balls that are selected at random from a container. If the number called matches a number on the player's card, the player marks it off.

The inventor quickly saw that, while the traditional game of bingo uses a set of numbers, it has never been used as an interactive game that incorporates United States history, in the form of its Presidents to be played by children as well as adults or played using multiple players, individually or in teams.

The inventor decided to include the information in the table on a bingo card. The markers would have an image of the president that correlated to the information on the appropriate space of the bingo card. After trial and error, the inventor realized that by requiring different formations to fill in a winning bingo card with correlating markers, even greater fun was added to the game.

However, the inventor saw that many people were alone, or couldn't find other players to play the game with them. The inventor made a puzzle version of the game that required a single player to fill in all of the spaces on the bingo card. The inventor also developed the game as a downloadable software application, so that it could be played on a smartphone by a single person.

For the foregoing reasons, there is a method for playing a presidential educational game that incorporates presidential figures with the classic game of Bingo in one embodiment; and a simple puzzle in a second embodiment.

Educational games have been utilized in the past; yet none with the present United States presidential characteristics of the present invention. See U.S. Pat. Nos. 3,368,816; 3,828,447; and 20130119609.

For the foregoing reasons, there is a method for playing a presidential educational game that entertains while also educating about the United States history and specifically, the Presidents of the United States.

### SUMMARY

The present invention describes a method for playing a presidential educational game. The method comprises a specially designed game that incorporates presidential figures with the classic game of Bingo in one embodiment; and a simple puzzle in a second embodiment. In one form, the game is designed to be used for educating about United States history with the historical figures comprising Presidents of the United States.

The game is appropriate for children as well as adults and may be used in educational or entertainment settings. The game may be especially helpful for educating newly arrived immigrants or students in government or civics class about the history and past presidents of the United States. The game may be created for multiple players, individually or in teams. The game may be played in traditional game board format, or as a downloadable software application on a smartphone or computer.

The method for playing the game utilizes at least one tablet. The tablet may be arranged as multiple square blocks in a grid formation. In one possible embodiment, the tablet includes forty-four blocks, with the first block representative of President George Washington, and the last block representative of President Barack Obama. Each block contains partial facts about each president. Each partial fact is displayed adjacent to, or inside the respective block. The partial facts may include the years that the president served, and the sequential number that the president served relative to the other presidents.

For example, Grover Cleveland, #24. In other embodiments, the partial facts depicted on the block may include additional educational facts about the presidents, including, without limitation: place of birth, birth date, death date, presidential term dates, party affiliation, and the vice president who served under the president.

The method of playing the game also allows each player to have a tablet. The tablet for each player is identical. In the tablet, the president, along with the respective partial facts, are arranged in sequential order. Though in an alternative embodiment, the blocks in the tablet will be randomized as to the order of presidents within each of the blocks, such that no two tablets are identical.

The game further includes a plurality of presidential markers corresponding to each of the partial facts of the presidents depicted in the blocks of the tablet. Each presidential marker comprises an image of the president. Additionally, the presidential marker may further include the dates of the presidential term, and other pertinent biographical information about the president.

The educational aspect, or challenge of the game is to match the image of the president of the president depicted on the presidential marker, with the correlating partial facts of the president displayed in the block of the tablet. This must be achieved in a predetermined formation, and before the other players complete the formation in order to win the game.

The game is played in two possible embodiments. In a multi-player embodiment, the game is played like Bingo. To play the game, each player receives a container that holds a plurality of presidential markers that represent all of the presidents depicted in the blocks of the tablet. The players take turns drawing a presidential marker from their respective container and show the picture to the other players. The player must then identify and match the presidential marker with the at least one partial fact displayed in the block of the tablet. If the player succeeds in identifying a match, the player may place the presidential marker over the appropriate block in the tablet.

A player wins if the presidential marker has been placed in the blocks to form a full horizontal formation, a vertical formation, or a diagonal formation. In other embodiments, the winning formation may include a T formation, an X formation, or a corner formation. In one embodiment, the first player to fill the appropriate winning formation wins the game.

Conversely, the player loses the game if any one of multiple events, or combinations thereof, occur: 1) if the player places the presidential marker in an incorrect block; or 2) if the player is not the first to fully fill in the horizontal, vertical, or diagonal formations on the blocks; or 3) if the player selects the most amount of erroneous blocks for the respective presidential markers.

In a second embodiment the game may be played like a puzzle by a single player. In this embodiment, the game is played by randomly grabbing a presidential marker from the container and matching the image of the president with the respective block containing the partial fact of the same president. The player completes the puzzle version of the game by completely filling in all of the blocks. However, it is significant to note that the player cannot fill in the blocks on the tablet completely if any of the presidential markers are in the wrong block, since only one presidential marker for each block is provided. Thus, the player must accurately match the presidential marker to the corresponding block to completely fill in the blocks on the tablet.

One objective of the present invention is to educate newly arrived immigrants and students in a civics class about the history and presidents of the United States.

Another objective of the present invention is to provide a game that is both entertaining and educational.

Another objective of the present invention is to learn information of past and present presidents, like, place of birth, birth date, death date, presidential term dates, party affiliation, and the vice president who served under the president.

Yet another objective of the present invention is to learn the sequential order of the presidents.

Yet another objective is to provide an inexpensive to manufacture game.

One advantage of the present invention is that the method for playing the game is easy to learn.

Another advantage of the present invention is that the method for playing the game can be played with minimal English speaking skills.

Yet another advantage of the present invention is that the game can be played with card panels, or on a downloadable software application.

### DRAWINGS

These and other features, aspects, and advantages of the present invention will become better understood with regard to the following description, appended claims, and drawings where:

FIG. 1 is a table of exemplary partial facts about a president;

FIG. 2 is a top view of an exemplary tablet for a method for playing a presidential educational game;

FIG. 3 is a top view of the tablet covered with presidential markers;

FIGS. 4A, 4B, and 4C are diagrams of the winning formations for the game, where FIG. 4A is a horizontal formation, FIG. 4B is a vertical formation, and FIG. 4C is a diagonal formation; and

FIG. 5 is a flowchart for an exemplary method for playing a presidential educational game.

### DESCRIPTION

The present invention is directed to a method 200 for playing a presidential educational game 100. The game 100 is configured to entertain while also educating about past and present Presidents of the United States. In a multi-player embodiment, the game 100 incorporates presidential figures with the classic game of Bingo. In a single player embodiment, the game 100 plays like a puzzle. However, the overarching objective of the game 100 is to educate about United States history and the historical figures comprising Presidents of the United States.

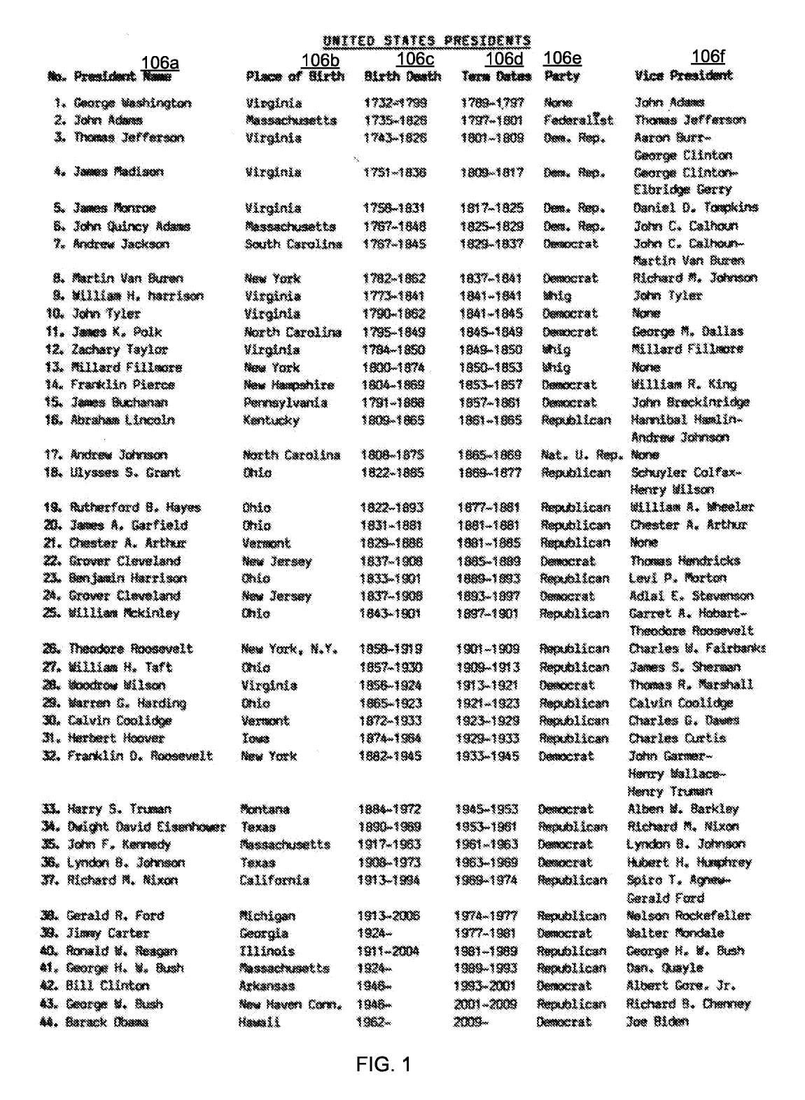

For example, some of the information that is learned in the game 100 comprises at least one partial fact 106a-f about the presidents, as depicted in the table of FIG. 1. The at least one partial fact 106a-f is effective for teaching about the president, and may include, without limitation, sequential position of the president, place of birth, birth date, death date, presidential term dates, party affiliation, and the vice president who served under the president.

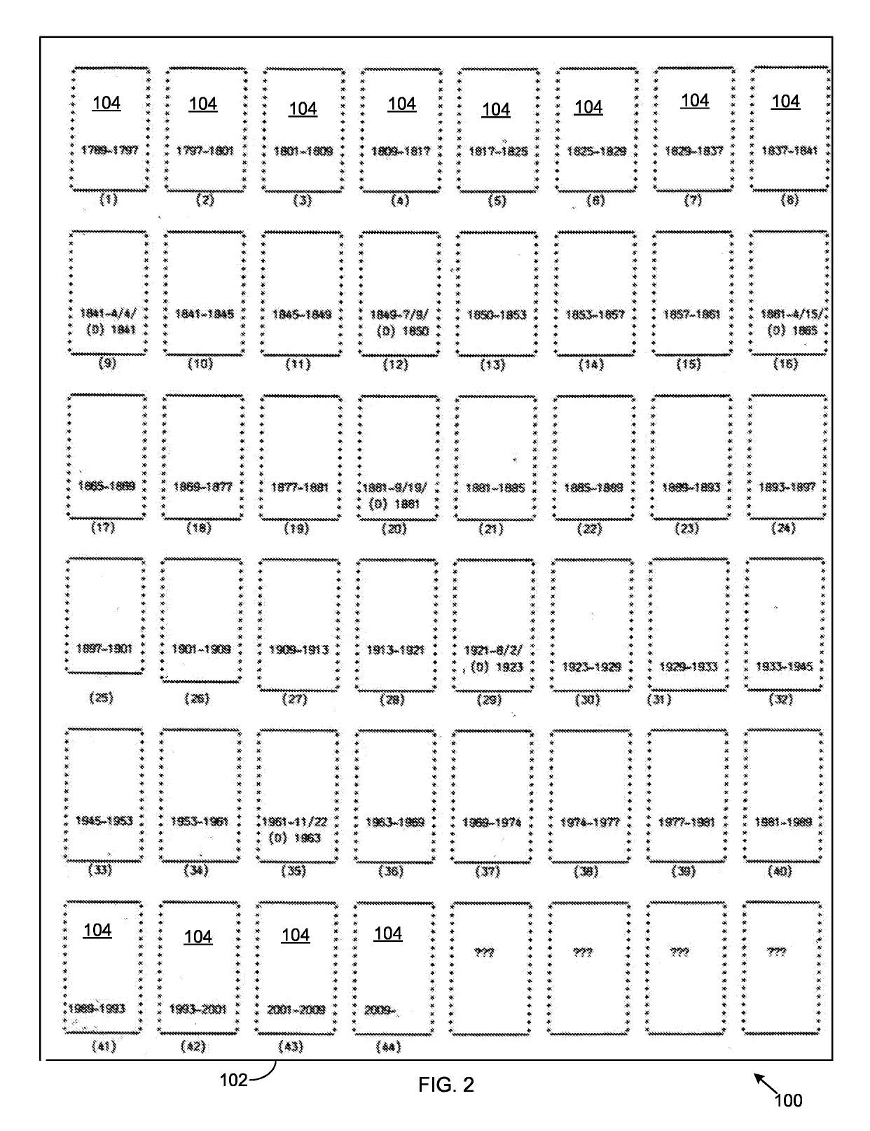

Turning now to FIG. 2, the method 200 for playing the game 100 utilizes at least one tablet 102. The tablet 102 may be arranged as multiple square blocks 104 in a grid formation. In one possible embodiment, the tablet 102 includes forty-four blocks 104, with the first block representative of President George Washington, and the last block representative of President Barack Obama.

Each block contains partial facts 106a-f about each president. Each partial fact 106a-f is displayed adjacent to, or inside the respective block. The partial fact 106a-f may include the years that the president served, and the sequential number that the president served relative to the other presidents. However, in alternative embodiments, more challenging and subtle partial fact 106a-f may be displayed on the blocks 104.

Those skilled in the art will recognize that the partial fact 106a-f displayed on the blocks 104 of the tablet 102 include the type of information that can be quizzed in citizenship test, or a civics class test. Thus, the game 100 is appropriate for preparing children as well as adults for tests, inquiries, and citizenship status. The game 100 may be especially helpful for educating newly arrived immigrants or students in government or civics class about the history and past presidents of the United States. The game 100 may be created for multiple players, individually or in teams. The game 100 may be played in traditional game board format, or as a downloadable software application on a computer, smartphone, tablet, or video console.

The partial fact 106a-f, in one embodiment, include the sequential number for the president and the years of terms served. For example, 1981-1989, #40. Those skilled in the art will recognize that the partial fact 106a-f in this case, correlates to President Ronald Reagan. However, in other embodiments, the partial fact 106a-f depicted on the block 104 may include additional educational facts about the presidents, including, without limitation: place of birth, birth date, death date, presidential term dates, party affiliation, and the vice president who served under the president. More advanced versions of the game 100 may further include famous battles that were fought by the president, the first lady, famous treaties signed by the president, and governmental positions occupied by the president.

The method 200 of playing the game 100 also allows each player to have a tablet 102. The tablet 102 for each player is identical. In the tablet 102, the president, along with the respective partial fact 106a-f, are arranged in sequential order. Though in an alternative embodiment, the blocks 104 in the tablet 102 will be randomized as to the order of presidents within each of the blocks 104, such that no two tablets 102 are identical. Suitable materials for the tablet 102 may include, without limitation, laminated cards, cardboard, paper, leather, and plastic. However, in a downloadable embodiment of the game 100, the tablet 102 appears on a display screen of a computer, tablet 102, smartphone, or video game console.

The game 100 further includes a plurality of presidential markers 108 corresponding to each of the partial fact 106a-f of the presidents depicted in the blocks 104 of the tablet 102. Each presidential marker comprises an image 110 of the president. Additionally, the presidential marker may further include the dates of the presidential term, and other pertinent biographical information about the president. The presidential markers 108 are sized and dimensioned to at least partially cover the blocks 104. Suitable materials for the presidential markers 108 may include, without limitation, laminated cards, cardboard, paper, leather, and plastic.

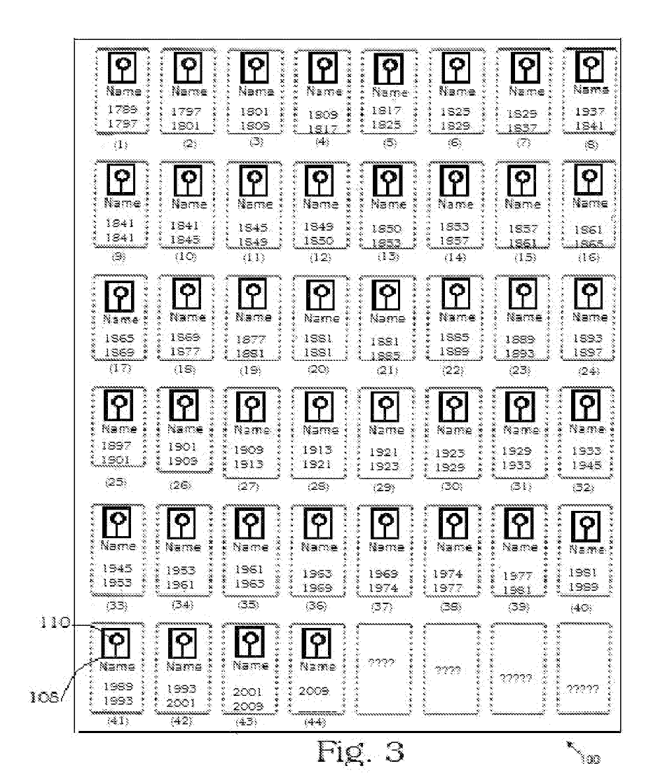

The educational aspect, or challenge of the game 100 is to match the image 110 of the president of the president depicted on the presidential marker, with the correlating partial fact 106a-f of the president displayed in the block of the tablet 102, as shown in FIG. 3. This must be achieved in a predetermined formation, and before the other players complete the formation in order to win the game 100. For example, if the image 110 depicts President Andrew Johnson, the presidential marker is placed on the 17^{th} sequential block on the tablet 102, since Andrew Johnson was the 17^{th} President of the United States.

The game 100 is played in two possible embodiments. In a multi-player embodiment, the game 100 is played like Bingo. To play the game 100, each player receives a container that holds a plurality of presidential markers 108 that represent all of the presidents depicted in the blocks 104 of the tablet 102. The container may include, without limitation, a cloth grab bag, ajar, a box, and a cubicle container. The container is preferably not transparent, such that the player cannot see which presidential marker is grabbed. This provides the random aspect of the game 100.

The players take turns drawing a presidential marker 108 from their respective container and show the picture to the other players. Each player must then identify and match the presidential marker 108 with the at least one partial fact 106a-f displayed in the block 104 of the tablet 102. If the player succeeds in identifying a match, the player may place the presidential marker 108 over the appropriate block 104 in the tablet 102.

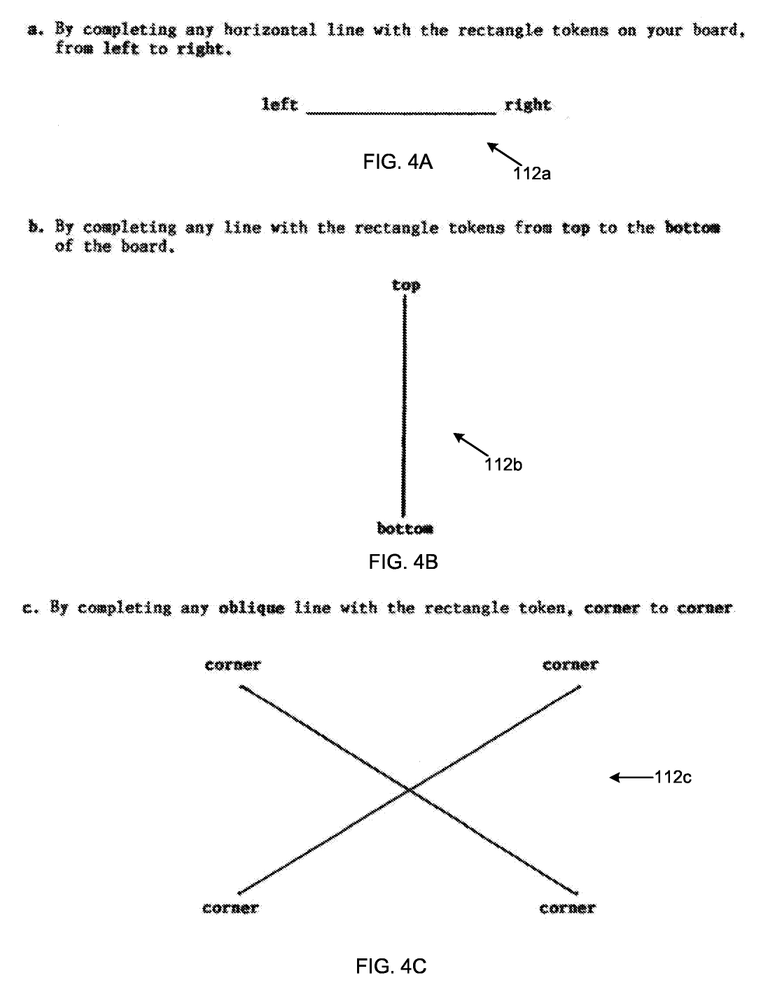

A player wins if the presidential marker 108 has been placed over the correlating blocks 104 to form a predetermined formation, which may include, without limitation, a full horizontal formation 112a (FIG. 4A), a vertical formation 112b (FIG. 4B), or a diagonal formation 112c from corner to corner of the tablet 102 (FIG. 4C). In other embodiments, the winning formation may include a T formation, an X formation, or a corner formation. In one embodiment, the first player to fill the appropriate winning formation 112a-c wins the game 100.

Conversely, the player loses the game 100 if any one of multiple events, or combinations thereof, occur: 1) if the player places the presidential marker 108 in an incorrect block 104; or 2) if the player is not the first to fully fill in the horizontal, vertical, or diagonal formations 112a-c on the blocks 104; or 3) if the player selects the most amount of erroneous blocks 104 for the respective presidential markers 108.

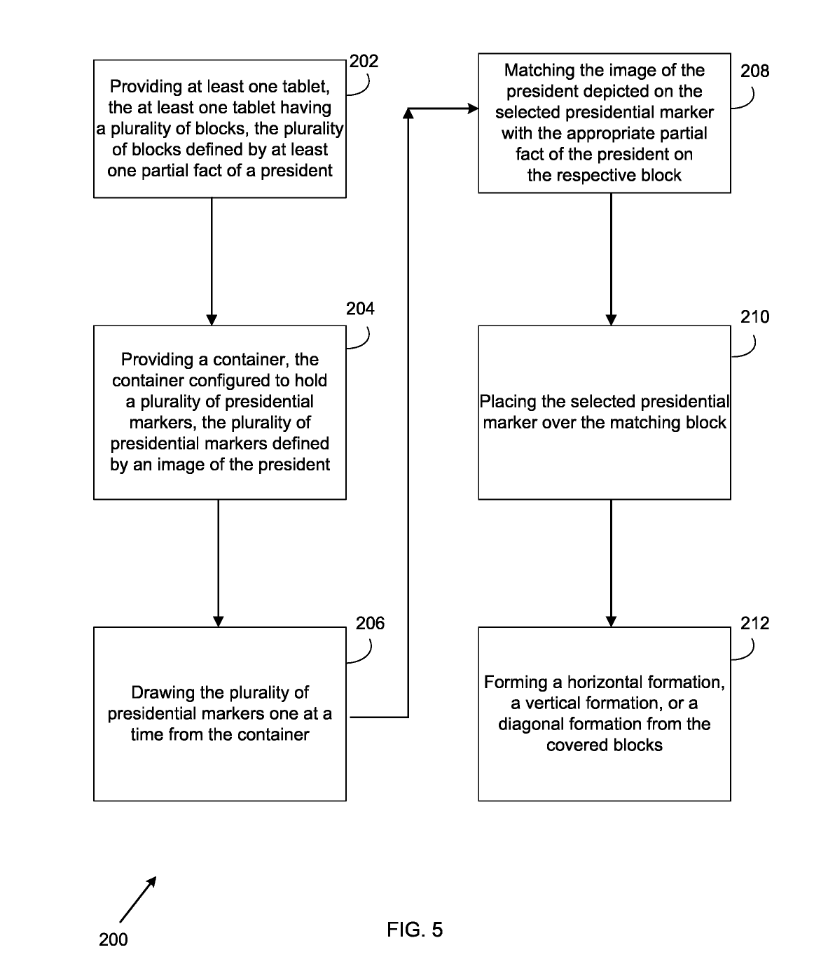

FIG. 5 illustrates a flowchart diagram of the method 200 for playing the Bingo embodiment of the game 100. The method 200 may include an initial Step 202 of providing at least one tablet 102, the at least one tablet 102 having a plurality of blocks 104, the plurality of blocks 104 defined by at least one partial fact 106a-f of a president. The tablet 102 may be arranged as multiple square blocks 104 in a grid formation. In one possible embodiment, the tablet 102 includes forty-four blocks 104 representative of all the presidents from President George Washington to President Barack Obama.

Each block 104 contains partial fact 106a-f about each president. Each partial fact 106a-f is displayed adjacent to, or inside the respective block 104. The partial fact 106a-f may include the years that the president served, and the sequential number that the president served relative to the other presidents.

The method 200 may further comprise a Step 204 of providing a container, the container configured to hold a plurality of presidential markers 108, the plurality of presidential markers 108 defined by an image 110 of the president. The container may include, without limitation, a cloth grab bag, a jar, a box, and a cubicle container. The container is preferably not transparent, such that the player cannot see which presidential marker 108 is grabbed. This provides the random aspect of the game 100.

A Step 206 includes drawing the plurality of presidential markers 108 one at a time from the container. The players take turns drawing a presidential marker 108 from their respective container and show the picture to the other players. In some embodiments, a Step 208 comprises matching the image 110 of the president depicted on the selected presidential marker 108 with the appropriate partial fact 106a-f of the president on the respective block 104. Each player must identify and match the presidential marker 108 with the at least one partial fact 106a-f displayed in the block of the tablet 102. If the player succeeds in identifying a match, the player may place the presidential marker 108 over the appropriate block 104 in the tablet 102.

A Step 210 includes placing the selected presidential marker 108 over the matching block 104. The presidential marker 108 is sized and dimensioned to cover the respective block 104. In some embodiments, a Step 212 may include forming a horizontal formation 112a, a vertical formation 112b, or a diagonal formation 112c from the covered blocks 104. A player wins if the presidential marker has been placed in the blocks 104 to form a predetermined formation, which may include, without limitation, a full horizontal formation 112a, a vertical formation 112b, or a diagonal formation 112c.

In a second embodiment the game 100 may be played like a puzzle by a single player. In this embodiment, the game 100 is played by randomly grabbing a presidential marker 108 from the container and matching the image 110 of the president with the respective block 104 containing the partial fact 106a-f of the same president. The player completes the puzzle version of the game 100 by completely filling in all of the blocks 104.

However, it is significant to note that the player cannot fill in the blocks 104 on the tablet 102 completely if any of the presidential markers 108 are in the wrong block 104, since only one presidential marker 108 for each block 104 is provided. Thus, the player must accurately match the presidential marker 108 to the corresponding block 104 to completely fill in the blocks 104 on the tablet 102.

In any case, the game 100 provides an educational and entertaining means to learn the Presidents of the United States and correlating information thereof. The game 100 may be played on a traditional board, downloadable as a software application, or even stored and accessed for playing from a storage medium, such as a server or video game console.

While the inventor's above description contains many specificities, these should not be construed as limitations on the scope, but rather as an exemplification of several preferred embodiments thereof. Many other variations are possible. For example, the images 110 on the presidential markers 108 could be images of Vice Presidents or Defense Secretaries. Accordingly, the scope should be determined not by the embodiments illustrated, but by the appended claims and their legal equivalents.

1. A method for playing a presidential educational game, the method comprising:
providing at least one tablet, the at least one tablet having a plurality of blocks, the plurality of blocks defined by at least one partial fact of a president;
providing a container, the container configured to hold a plurality of presidential markers, the plurality of presidential markers defined by an image of the president;
drawing the plurality of presidential markers one at a time from the container;
matching the image of the president depicted on the selected presidential marker with the appropriate partial fact of the president on the respective block;
placing the selected presidential marker over the matching block; and
forming a horizontal formation, a vertical formation, or a diagonal formation from the covered blocks.

2. The method of claim 1, wherein the tablet is a laminated panel having a substantially rectangular shape.

3. The method of claim 1, wherein the plurality of blocks are forty-four blocks.

4. The method of claim 1, wherein the plurality of blocks are equivalent to the number of past and present presidents.

5. The method of claim 1, wherein the president is the President of the United States.

6. The method of claim 1, wherein the container is a cloth grab bag.

7. The method of claim 1, wherein the at least one partial fact includes at least one member selected from the group consisting of: place of birth, birth date, death date, presidential term dates, party affiliation, and the vice president who served under the president.

8. The method of claim 1, wherein the plurality of presidential markers depict each president past and present.

9. The method of claim 1, wherein the container holds one presidential marker for each correlating block on the tablet.

10. The method of claim 1, wherein the game is won by the first player to cover the blocks in a horizontal formation, a vertical formation, or a diagonal formation.

11. The method of claim 1, wherein the game is a multi-player game.

12. The method of claim 1, wherein the game is downloadable as a software application.

13. A non-transitory program storage device readable by a machine tangibly embodying a program of instructions executable by the machine to perform a method for playing a presidential educational game, the method comprising the steps of:
Providing a computer code for providing at least one tablet, the at least one tablet having a plurality of blocks, the plurality of blocks defined by at least one partial fact of a president;
Providing a computer code for providing a container, the container configured to hold a plurality of presidential markers, the plurality of presidential markers defined by an image of the president;
Providing a computer code for drawing the plurality of presidential markers one at a time from the container;
Providing a computer code for matching the image of the president depicted on the selected presidential marker with the appropriate partial fact of the president on the respective block;
Providing a computer code for placing the selected presidential marker over the matching block; and
Providing computer a code for forming a horizontal formation, a vertical formation, or a diagonal formation from the covered blocks.

14. The method of claim 13, wherein the game is won by the first player to cover the blocks in a horizontal formation, a vertical formation, or a diagonal formation.

15. The method of claim 13, wherein the at least one partial fact includes at least one member selected from the group consisting of: place of birth, birth date, death date, presidential term dates, party affiliation, and the vice president who served under the president.

16. A method for playing a presidential educational game, the method comprising:
providing at least one tablet, the at least one tablet having a plurality of blocks, the plurality of blocks defined by at least one partial fact of a president;
providing a container, the container configured to hold a plurality of presidential markers, the plurality of presidential markers defined by an image of the president;
drawing the plurality of presidential markers one at a time from the container;
matching the image of the president depicted on the selected presidential marker with the appropriate partial fact of the president on the respective block;
placing the selected presidential marker over the matching block; and
covering all of the plurality of blocks with the matching presidential marker.

16. The method of claim 16, wherein the tablet is a laminated panel having a substantially rectangular shape.

17. The method of claim 16, wherein the plurality of blocks are equivalent to the number of past and present presidents.

18. The method of claim 16, wherein the plurality of presidential markers depict each president past and present.

19. The method of claim 16, wherein the at least one partial fact includes at least one member selected from the group consisting of: place of birth, birth date, death date, presidential term dates, party affiliation, and the vice president who served under the president.

20. The method of claim 16, wherein the container holds one presidential marker for each correlating block on the tablet.

21. The method of claim 16, wherein the game is won by the first player to cover all of the blocks with the matching presidential marker.
